(19) United States
(12) Patent Application Publication
(10) Pub. No.: US 2026/0212071 A1
(43) Pub. Date: Jul. 23, 2026

(54) Method for building a linearized model of the roll channel of flying objects

(71) Applicant: VIETTEL GROUP, Ha Noi City (VN)

(72) Inventors: THI DIEU LINH DANG, Ha Noi City (VN); KIEM CHIEN NGUYEN, Ha Noi City (VN)

(73) Assignee: VIETTEL GROUP, Ha Noi City (VN)

(21) Appl. No.: 19/335,790

(22) Filed: Sep. 22, 2025

(30) Foreign Application Priority Data
Jan. 22, 2025 (VN) 1-2025-00514

(51) Int. Cl. G06F 30/20; G06F 111/10

(52) U.S. Cl. CPC G06F 30/20; G06F 2111/10

(57) ABSTRACT

Linearized roll channel model for flight objects (FOs) constructing method has four basic steps, using the general system of equations describing motion of the FO in the horizontal plane. Assume that the FO is symmetric, initial conditions are zero, and neglect roll channel control angle influence on yaw channel forces and moments. Derive a new linear roll channel model accurately representing the FO. Basing a roll channel controller design on an accurate FO representing new linear roll channel model to achieve superior control performance, significantly reducing roll angle amplitude and enabling fast response. The is applicable to FOs roll channel study, aerodynamic coefficients identification from actual experimental data, and sensors and actuators selection criteria establishments, and can be used for various types of FOs, including commercial aircraft, fighter jets, unmanned aerial vehicles, and advanced weapon systems, especially those with high lateral stability and maneuverability under conditions involving significant sideslip angles.

### TECHNICAL FIELDS MENTIONED

The invention proposes to a method for building a linearized model of the roll channel for flying objects (FOs). Specifically, a method for constructing the linearized model of the roll channel is proposed for analyzing and understanding the roll channel of FOs. It is used to evaluate the effectiveness of control in stabilizing the roll angular velocity across all flying vehicles. Additionally, it supports the design of control coefficient sets for the autopilot loop of unmanned flying vehicles. The method can be applied to various types of flying objects, including commercial aircraft, fighter jets, and unmanned aerial vehicles, particularly those with high lateral stability and maneuverability under conditions involving significant sideslip angles.

### TECHNICAL STATUS OF INVENTION

In the design control system for flying objects (FOs), a crucial initial step is to understand the FO through the construction of linearized models. The mathematical model of the flying vehicle is represented by a system of six degrees of freedom equations describing forces and moments occurring during operation. Theoretically, these equations are nonlinear due to the complex spatial motion of the vehicle, encompassing both vertical and horizontal planes. Under equilibrium conditions (also known as trim condition, where the total moment acting on the vehicle is zero), the force and moment equations can be linearized to form a linear model, from which transfer functions representing the vehicle can be derived. By knowing these transfer functions, it is possible to evaluate the influence of configuration parameters (such as mass, length, fuselage diameter, moment of inertia, etc.) and aerodynamic parameters on the FO's response to control surface deflections, in other words, the control effectiveness. This enables readjustment of the initial design to achieve an optimal configuration. Moreover, the characteristic transfer functions of the flying vehicle can be used to identify aerodynamic coefficients from experimental data, thereby correcting aerodynamic data and improving simulation accuracy. This is particularly significant in Vietnam, where challenges exist in flight configuration design due to the lack of wind tunnel facilities and aerodynamic measurement equipment, resulting in reliance on commercial semi-empirical software with limited reliability and considerable error margins. Additionally, the transfer functions are utilized to study the effects of flight conditions, such as velocity, altitude, temperature, and pressure, on critical flying object parameters. Investigations across varying flight conditions reveal the range of significant characteristic parameters, such as roll angular velocity and control surface-generated moments in the roll channel. Based on these analyses, criteria for selecting suitable sensors and actuators compatible with the flight control system are established. For unmanned flying objects, these transfer functions support the design of control coefficient sets for autopilot loops stabilizing roll angular velocity. This is an essential aspect of flight control to ensure stability for both the object and onboard sensors (e.g., radar devices, altimeters), which require the roll angle to remain within specific limits to maintain accuracy. Consequently, the FO can follow flight trajectories precisely with minimal error. A flying object can be linearized through various methods, each corresponding to different transfer functions. The closer the linearized model approximates the actual flying vehicle, the better the control effectiveness. Nowadays, the most widely known and used roll linearization model is the roll mode model, which approximates the vehicle's roll motion by neglecting the effects of sideslip angle and yaw angle. This roll mode model considers only the pure roll moment. However, when applied to flying objects with significant lateral stability, this model presents multiple issues:
Low accuracy in vehicle description. Parameter identification from experimental data using the roll mode model yields low compatibility (below 60%).
Poor control effectiveness. In flight conditions with large sideslip angles, designing control coefficients based on the roll mode model leads to sudden increases in roll angle and prolonged stabilization times. Large sideslip angles may arise from several objective causes, including manufacturing deviations in fuselage production; requirements for rapid maneuvering in the horizontal plane; misalignment of engine thrust direction relative to the vehicle's longitudinal axis; changes in vehicle size or mass (fuel consumption, payload changes during transport missions, etc.). These causes are objective and unavoidable.
The use of the roll mode model for sensor and actuator selection often fails to match actual conditions, requiring recalculations and adjustments.

The novel method for constructing a linearized roll channel model has been researched and developed to fully meet the above requirements. Key features include:
High-accuracy description of the FO by incorporating components related to the sideslip angle. Identification results using this new model demonstrate very high compatibility (above 94%).
Enhanced control effectiveness for stabilizing roll angular velocity when used to design control coefficients for the autopilot loop of the FO. The FO rotates with a smaller roll angle and achieves faster stabilization under large sideslip angle conditions.
Provision of more realistic criteria for selecting sensors and actuators, thereby reducing costs in the research, design, and manufacturing process.

The method is applicable to all types of flying vehicles operating under various flight conditions.

### TECHNICAL NATURE OF INVENTION

The purpose of the invention is to develop a new linearized model of the roll channel by incorporating the sideslip angle component into the characteristic transfer function of the roll channel. This enhancement aims to represent the flight object (FO) more accurately, thereby enabling more precise analysis and evaluation of the FO and providing suitable adjustments to optimize the initial design. Furthermore, motivated by the need to verify and assess errors in aerodynamic coefficient calculation software, the invention provides a model for identifying the characteristic aerodynamic coefficients of the roll channel of FOs based on actual experimental data. This allows correction of necessary aerodynamic data, serving as input for more accurate FO simulations. In addition, the invention is applied to determine the range of variation of important characteristic parameters in the roll channel, upon which appropriate criteria are established for selecting sensors and flight control systems. A very important aspect of the invention is its application in designing the control coefficient set to stabilize the roll angular velocity for the autopilot loop of unmanned flight objects. The method for constructing the new linearized roll channel model can be used for various types of FOs, including commercial aircraft, fighter jets, and unmanned aerial vehicles, especially those with high lateral stability and maneuverability under conditions involving significant sideslip angles. The method described in the invention begins by considering the general system of equations describing the motion of the FO in the horizontal plane under steady-state equilibrium conditions, then constructs the general transfer function of the roll channel and performs approximations to derive a reduced transfer function.

To achieve one or more of the aforementioned objectives, the method described in the invention is carried out through the following steps:
Step 1: construct a general model describing the motion of the flight object in the horizontal plane under steady-state equilibrium conditions;
Step 2: develop and analyze the characteristic equation; Step 3: construct the general transfer function of the roll channel;
Step 4: derive the reduced transfer function of the roll channel from the general transfer function.

### BRIEF DESCRIPTION OF DRAWINGS

FIG. 1 is the basic block diagram of a roll angle stabilization control system for flight objects;

FIG. 2 is the table of formulas for lateral derivative coefficients;

FIG. 3 is the navigation coordinate system;

FIG. 4 is the body-fixed coordinate system.

### DETAILED DESCRIPTION OF INVENTION

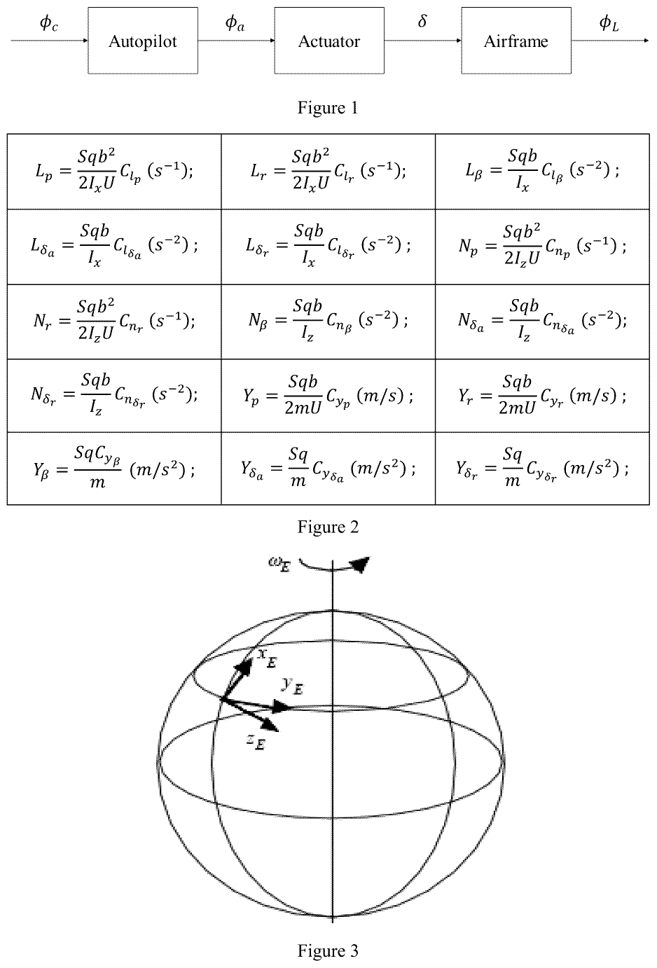

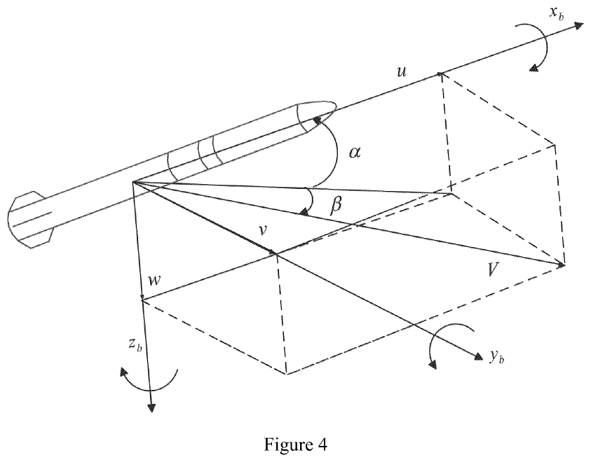

Referring to FIG. 1, there are three basic blocks of the roll angle stabilization control system: the autopilot block, the actuator block, and the airframe block. φ_{c} is the commanded roll angle calculated from navigation algorithms; δₐ is the commanded aileron deflection angle computed by the autopilot block from control algorithms; δ is the actual aileron deflection angle; φ_{L} is the roll angle feedback from the flight object (FO). From FIG. 1, it can be seen that the flight object block is a very important part of the roll channel flight control system. During the design process of the FO control system, the essential first step is to understand the FO through the construction of transfer functions. Mathematically, the FO is represented by a system of nonlinear six degrees of freedom equations describing the forces and moments acting on the FO during spatial motion. Two commonly used coordinate systems for referencing the position, velocity, and state of the FO are the navigation coordinate system O_{E}X_{E}Y_{E}Z_{E} and the body-fixed coordinate system O_{b}X_{b}Y_{b}Z_{b}. Referring to FIG. 3, the navigation coordinate system O_{E}X_{E}Y_{E}Z_{E} has its origin OF located at the initial position of the FO (before takeoff). The axis O_{E}X_{E} is tangent to the meridian at O_{E}, with the positive direction pointing towards the Earth's North Pole. The axis O_{E}Y_{E} is tangent to the parallel at OF, with the positive direction pointing eastward in the direction of Earth's rotation. The axis O_{E}Z_{E} completes a right-handed coordinate system with the other two axes. Referring FIG. 4, the body-fixed coordinate system O_{b}X_{b}Y_{b}Z_{b} has its origin Ob at the FO's center of gravity. The axis O_{b}X_{b} aligns with the longitudinal axis of the FO, the axis O_{b}Z_{b} points downward toward the belly of the FO, and the axis Ob Yb completes a right-handed coordinate system with the other two axes. The motion of the FO in space is complex, consisting of two fundamental types of motion: translational motion and rotational motion around the axes of the body-fixed coordinate system. The task of the roll angular velocity stabilization control system is to stabilize the rotational motion of the FO about the O_{b}X_{b} axis. For an observer, the FO's motion can be divided into two components occurring in two planes: the vertical plane O_{E}X_{E}Z_{E} and the horizontal plane O_{E}X_{E}Y_{E}. Theoretically, the motions in these two planes are interrelated and influence each other. Approximately, the horizontal motion (motion in the horizontal plane) can be considered to be caused by lateral forces (the aerodynamic force component along the O_{b}Y_{b} axis), roll moment (moment about the O_{b}X_{b} axis), and yaw moment (moment about the O_{b}Z_{b} axis).

Before implementing the method described in the invention, it is necessary to prepare the input data consisting of the following parameters:
+b is the reference wingspan;
+U is the velocity of the FO;
+m is the mass of the FO;
+S is the reference area;
+Iₓ, I_{z} are the moments of inertia of the FO about the body-fixed coordinate axes O_{b}X_{b} and O_{b}Z_{b}, respectively;
+C_{y}_{ₚ}, C_{y}_{ᵣ}, C_{y}_{_{β}}, Cₗ_{ₚ}, Cₗ_{ᵣ}, Cₗ_{_{β}}, Cₙ_{ₚ}, Cₙ_{ᵣ}, Cₙ_{_{β}} are the aerodynamic derivative coefficients of the FO itself, obtained from two-dimensional lookup tables with respect to angle of attack and flight velocity;

$$+ {C}_{{y}_{{δ}_{a}}} , {C}_{{l}_{{δ}_{a}}} , {C}_{{n}_{{δ}_{a}}}$$

are the aerodynamic derivative coefficients of the FO generated by the control surface deflection δₐ. These coefficients are provided as three-dimensional lookup tables with respect to angle of attack, velocity, and deflection angle δₐ.

Specifically, the method for constructing the linearized roll channel model for the FO includes the following steps:
Step 1: construct a general model describing the motion of the flight object in the horizontal plane under steady-state equilibrium conditions using the Laplace operator. The input is a system of three equations, in which two equations describe the rotational moments of the FO about the body-fixed coordinate axes O_{b}X_{b} and O_{b}Z_{b}, and one equation describes the lateral force, as follows:

$$- \frac{b}{2 U} {C}_{{y}_{p}} \dot{ϕ} - {C}_{{y}_{ϕ}} ϕ + ( \frac{mU}{Sq} - \frac{b}{2 U} {C}_{{y}_{r}} ) \dot{ψ} - {C}_{{y}_{ψ}} ψ + \frac{mU}{Sq} \dot{β} - {C}_{{y}_{β}} β = {C}_{{y}_{{δ}_{a}}} \qquad ( 1 )$$

$$\frac{{I}_{x}}{S q b} \ddot{ϕ} - \frac{b}{2 U} {C}_{{l}_{p}} \dot{ϕ} - \frac{b}{2 U} {C}_{{l}_{r}} \dot{ψ} - {C}_{{l}_{β}} β = {C}_{{l}_{{δ}_{a}}} \qquad ( 2 )$$

$$- \frac{b}{2 U} {C}_{{n}_{p}} \dot{ϕ} + \frac{{I}_{z}}{S q b} \ddot{ψ} - \frac{b}{2 U} {C}_{{n}_{r}} \dot{ψ} - {C}_{{n}_{β}} β = {C}_{{n}_{{δ}_{a}}} \qquad ( 3 )$$

Where:
φ is the roll angle of the FO;
ψ is the yaw angle of the FO;
β is the sideslip angle;
q is the dynamic pressure, determined by the expression:

$$q = \frac{1}{2} ρ {U}^{2} ,$$

where ρ is the static pressure, obtained from altitude data at steady-state equilibrium conditions;
C_{y}_{_{φ}} is determined by the expression:

$${C}_{{y}_{ϕ}} = \frac{mg}{Sq} cos θ ,$$

where g is the gravitational acceleration of the Earth, and θ is the pitch angle of the FO. Under steady-state equilibrium conditions, θ can be assumed to be zero. Therefore,

$${C}_{{y}_{ϕ}} = \frac{mg}{Sq} cos θ .$$

C_{y}_{_{ψ}} is determined by the expression:

$${C}_{{y}_{ψ}} = \frac{mg}{Sq} sin θ .$$

At steady-state equilibrium, C_{y}_{_{ψ}}=0.
Step 1 uses the following initial assumptions:
+Moments of inertia coefficients are neglected;
+The influence of the rudder deflection angle is ignored;
+Initial conditions are zero.

Using the reference aerodynamic coefficients from FIG. 2, equations (1), (2), (3) can be rewritten as follows:

$$\ddot{ϕ} - {L}_{p} \dot{ϕ} - {L}_{r} \dot{ψ} - {L}_{β} β = {L}_{{δ}_{a}} \qquad ( 4 )$$

$$- {N}_{p} \dot{ϕ} + \ddot{ψ} - {N}_{r} \dot{ψ} - {N}_{β} β = {N}_{{δ}_{a}} \qquad ( 5 )$$

$$- {Y}_{p} \dot{ϕ} - g ϕ + ( U - {Y}_{r} ) \dot{ψ} + U \dot{β} - {Y}_{β} β = {Y}_{{δ}_{a}} \qquad ( 6 )$$

By applying the Laplace operator, the general model describing the motion in the horizontal plane is obtained as follows:

$$( {s}^{2} - {L}_{p} s ) ϕ ( s ) - {L}_{r} \dot{ψ} ( s ) - {L}_{β} β ( s ) = {L}_{{δ}_{a}} {δ}_{a} \qquad ( 7 )$$

$$- {N}_{p} s ϕ ( s ) + ( s - {N}_{r} ) \dot{ψ} ( s ) - {N}_{β} β ( s ) = {N}_{{δ}_{a}} {δ}_{a} \qquad ( 8 )$$

$$- ( {Y}_{p} s + g ) ϕ ( s ) + ( U - {Y}_{r} ) \dot{ψ} ( s ) + ( Us - {Y}_{β} ) β ( s ) = {Y}_{{δ}_{a}} {δ}_{a} \qquad ( 9 )$$

Step 2: construct and analyze the characteristic equation. The characteristic equation of the system of three equations (7), (8), and (9) is:

$$∇ = \vert \begin{matrix}( s - {L}_{p} s ) & - {L}_{r} & - {L}_{β} \\ - {N}_{p} s & ( s - {N}_{r} ) & - {N}_{β} \\ - ( {Y}_{p} s + g ) & U - {Y}_{r} & Us - {Y}_{β}\end{matrix} \vert = 0 \qquad ( 10 )$$

The expansion of equation (10) is a quartic equation of the form:

$$∇ = U {s}^{4} + {a}_{3} {s}^{3} + {a}_{2} {s}^{2} + {a}_{1} s + {a}_{0} \qquad ( 11 )$$

Where aᵢ(i=0̅,̅3̅) are functions of the aerodynamic derivative coefficients, mass, velocity, altitude, and moments of inertia of the FO. The roots of equation (11) include two real roots and one pair of complex conjugate roots corresponding to the characteristic oscillations of the flight object as follows:
The first oscillation: slow converging or diverging oscillation (spiral mode);
The second oscillation: fast converging oscillation (rolling mode);
The third oscillation: damped oscillation with a small damping coefficient and low frequency (Dutch roll mode).

The characteristic equation is rewritten as follows:

$$∇ = \frac{U {ω}_{D}^{2}}{{τ}_{s} {τ}_{r}} ( {τ}_{s} s + 1 ) ( {τ}_{r} s + 1 ) [ {( \frac{s}{{ω}_{D}} )}^{2} + \frac{2 {ζ}_{D}}{{ω}_{D}} s + 1 ] \qquad ( 12 )$$

Where:
τₛ is the time constant of the first oscillation;
τᵣ is the time constant of the second oscillation;
ζ_{D, ω}_{_{D}} are respectively the damping ratio and natural frequency of the third oscillation.

For a given flight object (FO) configuration at steady-state equilibrium conditions, the coefficients aᵢ(i=0̅,̅3̅) of equation (11) are fixed. Therefore, the parameters τₛ, τᵣ, ζ_{D}, ω_{D} are found by solving equation (11) using the “roots” command in MATLAB.
Step 3: construct the general transfer function of the roll channel. After analyzing the aerodynamic characteristics of many types of FO, especially high-tech, fast-moving weapons, it was found that when deflecting the aileron, a very small insignificant yaw moment is generated. The coefficients

$${C}_{{n}_{{δ}_{a}}} and {C}_{{y}_{{δ}_{a}}}$$

calculated by using simulation softwares (for examples DATCOM, ANSYS) are nearly zero. On that basis, step 3 assumes that the influence of the control surface deflection angle δₐ on the yawing moment and lateral force is very small, so the aerodynamic coefficients

$${C}_{{n}_{{δ}_{a}}} and {C}_{{y}_{{δ}_{a}}}$$

can be neglected. The general transfer function of the roll channel with input signal δₐ and output signal φ is:

$$\frac{ϕ ( s )}{{δ}_{a} ( s )} = \frac{{L}_{{δ}_{a}} \vert \begin{matrix}s - {N}_{r} & - {N}_{β} \\ U - {Y}_{r} & Us - {Y}_{β}\end{matrix} \vert}{∇} \qquad ( 13 )$$

Notation:

$${∇}_{D R} = \vert \begin{matrix}s - {N}_{r} & - {N}_{β} \\ U - {Y}_{r} & Us - {Y}_{β}\end{matrix} \vert \qquad ( 14 )$$

The expansion of equation (14) is:

$${∇}_{D R} = {Us}^{2} - ( {Y}_{β} + {UN}_{r} ) s + {Y}_{β} {N}_{r} - {N}_{β} {Y}_{r} + {UN}_{β} \qquad ( 15 )$$

Equation (15) can be rewritten in the following form:

$${∇}_{D R} = U {ω}_{D R}^{2} [ {( \frac{s}{{ω}_{D R}} )}^{2} + \frac{2 {ζ}_{D R}}{{ω}_{D R}} s + 1 ] \qquad ( 16 )$$

ζ_{DR} and ω_{DR} are defined by the following expressions:

$${ζ}_{D R} = - \frac{1}{2 {ω}_{D R}} \frac{{Y}_{β} + {UN}_{r}}{U} \qquad ( 17 )$$

$${ω}_{D R} = \sqrt{\frac{{Y}_{β} {N}_{r} - {N}_{β} {Y}_{r} + {UN}_{β}}{U}} \qquad ( 18 )$$

The general transfer function of the roll channel is:

$$\frac{ϕ ( s )}{{δ}_{a} ( s )} = \frac{{L}_{{δ}_{a}} {τ}_{s} {{τ}_{r} ( \frac{{ω}_{DR}}{{ω}_{D}} )}^{2} [ {( \frac{s}{{ω}_{DR}} )}^{2} + \frac{2 {ζ}_{DR}}{{ω}_{DR}} s + 1 ]}{( {τ}_{s} s + 1 ) ( {τ}_{r} s + 1 ) [ {( \frac{s}{{ω}_{D}} )}^{2} + \frac{2 {ζ}_{D}}{{ω}_{D}} s + 1 ]} \qquad ( 19 )$$

Step 4: derive the reduced transfer function of the roll channel from the general transfer function. Using equations (12), (17), (18) and FIG. 2, all coefficients of the equation (19) are fixed for a given flight object (FO) configuration at steady-state equilibrium conditions. First, using the “bode” command in MATLAB to plot magnitude for φ(s)/δₐ(s) transfer function versus s=jω, the results indicate that the numerator quadratic effectively cancels the denominator quadratic. Second, using the “step” command in MATLAB to plot step responses with deflection angle of one degree of φ(s)/δₐ(s) transfer function and the transfer function having the following expression:

$$\frac{{ϕ}_{1} ( s )}{{δ}_{a} ( s )} = \frac{{L}_{{δ}_{a}} {τ}_{s} {{τ}_{r} ( \frac{{ω}_{DR}}{{ω}_{D}} )}^{2}}{( {τ}_{s} s + 1 ) ( {τ}_{r} s + 1 )}$$

it was found that two above step responses are close to each other with 0.01% error after one second. Finally, from observing equation (19), the roll angle transfer function can be approximated as follows:

$$\frac{ϕ ( s )}{{δ}_{a} ( s )} = \frac{{K}_{x}}{( {τ}_{s} s + 1 ) ( {τ}_{r} s + 1 )} \qquad ( 20 )$$

Kₓ is determined by the expression:

$${K}_{x} = {L}_{{δ}_{l}} {τ}_{s} {{τ}_{r} ( \frac{{ω}_{D R}}{{ω}_{D}} )}^{2} \qquad ( 21 )$$

The transfer function of the roll angular velocity with input signal being the roll channel control angle δₐ is:

$$\frac{\dot{ϕ} ( s )}{{δ}_{a} ( s )} = \frac{{K}_{x} s}{( {τ}_{s} s + 1 ) ( {τ}_{r} s + 1 )} \qquad ( 22 )$$

### Effect of Invention

The method for constructing the linearized roll channel model for the flight object (FO) has achieved the following results:
More accurate description of the FO. The FO's response to a control surface deflection angle closely matches the general model.
Identification results using the new linear model demonstrate very high compatibility (94.86%).
Increased effectiveness in stabilizing the roll angle. The roll angle decreases rapidly, and the time to stabilize the roll angular velocity is shorter.
Provides more practical criteria for selecting suitable sensors and actuators, reducing costs during research, design, and manufacturing processes.

1. A method for constructing a linearized roll channel model for a flight object (FO) is carried out through the following steps:
step 1: construct a general model describing the motion of the FO in the horizontal plane under steady-state equilibrium conditions by using a Laplace operator; the input consists of a system of three equations, in which two equations describe the rotational moments of the FO about a body-fixed coordinate axes O_{b}X_{b} and O_{b}Z_{b} one equation describes the lateral force as follows:
$$- \frac{b}{2 U} {C}_{{y}_{p}} \dot{ϕ} - {C}_{{y}_{ϕ}} ϕ + ( \frac{m U}{S q} - \frac{b}{2 U} {C}_{{y}_{r}} ) \dot{ψ} - {C}_{{y}_{ψ}} ψ + \frac{mU}{S q} \dot{β} - {C}_{{y}_{β}} β = {C}_{{y}_{{δ}_{a}}} \qquad ( 1 )$$
$$\frac{{I}_{x}}{S q b} \ddot{ϕ} - \frac{b}{2 U} {C}_{{l}_{p}} \dot{ϕ} - \frac{b}{2 U} {C}_{{l}_{r}} \dot{ψ} - {C}_{{l}_{β}} β = {C}_{{l}_{{δ}_{a}}} \qquad ( 2 )$$
$$- \frac{b}{2 U} {C}_{{n}_{p}} \dot{ϕ} + \frac{{I}_{Z}}{S q b} \ddot{ψ} - \frac{b}{2 U} {C}_{{n}_{r}} \dot{ψ} - {C}_{{n}_{β}} β = {C}_{{n}_{{δ}_{a}}} \qquad ( 3 )$$
where:
φ is a roll angle of the FO;
ψ is a yaw angle of the FO;
β is a sideslip angle;
q is a dynamic pressure, determined by an expression:
$$q = \frac{1}{2} ρ {U}^{2} ,$$
where ρ is a static pressure, obtained from altitude data under steady-state equilibrium conditions;
C_{y}_{_{φ}} is determined by an expression:
$${C}_{{y}_{ϕ}} = \frac{m g}{S q} cos θ ,$$
where g is a gravitational acceleration of the Earth, and θ is a pitch angle of the FO; under steady-state equilibrium conditions, θ can be assumed to be zero; thus,
$${C}_{{y}_{ϕ}} = \frac{m g}{S q} ;$$
C_{y}_{_{ψ}} is determined by an expression:
$${C}_{{y}_{ψ}} = \frac{m g}{S q} sin θ ;$$
at steady-state equilibrium, C_{y}_{_{ψ}}=0;
step 1 uses the following initial assumptions:
moments of inertia coefficients are neglected;
influence of the rudder deflection angle is ignored;
initial conditions are zero;
using aerodynamic coefficients, equations (1), (2), and (3) is rewritten as follows:
$$\ddot{ϕ} - {L}_{p} \dot{ϕ} - {L}_{r} \dot{ψ} - {L}_{β} β = {L}_{{δ}_{a}} \qquad ( 4 )$$
$$- {N}_{p} \dot{ϕ} + \ddot{ψ} - {N}_{r} \dot{ψ} - {N}_{β} β = {N}_{{δ}_{a}} \qquad ( 5 )$$
$$- {Y}_{p} \dot{ϕ} - g ϕ + ( U - {Y}_{r} ) \dot{ψ} + U \dot{β} - {y}_{β} β = {Y}_{{δ}_{a}} \qquad ( 6 )$$
by applying the Laplace operator, a general model describing the motion in the horizontal plane is obtained as follows:
$$( {s}^{2} - {L}_{p} s ) ϕ ( s ) - {L}_{r} \dot{ψ} ( s ) - {L}_{β} β ( s ) = {L}_{{δ}_{a}} {δ}_{a} \qquad ( 7 )$$
$$- {N}_{p} s ϕ ( s ) + ( s - {N}_{r} ) \dot{ψ} ( s ) - {N}_{β} β ( s ) = {N}_{{δ}_{a}} {δ}_{a} \qquad ( 8 )$$
$$- ( {Y}_{p} s + g ) ϕ ( s ) + ( U - {Y}_{r} ) \dot{ψ} ( s ) + ( Us - {Y}_{β} ) β ( s ) = {Y}_{{δ}_{a}} {δ}_{a} \qquad ( 9 )$$
step 2: construct and analyze a characteristic equation, the characteristic equation of the system of three equations (7), (8), and (9) is:
$$∇ = \vert \begin{matrix}( {s}^{2} - {L}_{p} s ) & - {L}_{r} & - {L}_{β} \\ - {N}_{p} s & ( s - {N}_{r} ) & - {N}_{β} \\ - ( {Y}_{p} s + g ) & U - {Y}_{r} & Us - {Y}_{β}\end{matrix} \vert = 0 \qquad ( 10 )$$
expansion of equation (10) is a quartic equation of a form:
$$∇ = U {s}^{4} + {a}_{3} {s}^{3} + {a}_{2} {s}^{2} + {a}_{1} s + {a}_{0} \qquad ( 11 )$$
where aᵢ(i=0̅,̅3̅) are functions of aerodynamic derivative coefficients, mass, velocity, altitude, and moments of inertia of the flight object (FO), roots of equation (11) include two real roots and one pair of complex conjugate roots corresponding to characteristic oscillations of the flight object as follows:
a first oscillation: slow converging or diverging oscillation (spiral mode);
a second oscillation: fast converging oscillation (rolling mode);
a third oscillation: damped oscillation with a small damping ratio and low frequency (Dutch roll mode);
the characteristic equation is rewritten as follows:
$$∇ = \frac{U {ω}_{D}^{2}}{{τ}_{s} {τ}_{r}} ( {τ}_{s} s + 1 ) ( {τ}_{r} s + 1 ) [ {( \frac{s}{{ω}_{D}} )}^{2} + \frac{2 {ζ}_{D}}{{ω}_{D}} s + 1 ] \qquad ( 12 )$$
where:
τₛ is a time constant of the first oscillation;
τᵣ is a time constant of the second oscillation;
ζ_{D}, ω_{D} are respectively a damping ratio and natural frequency of the third oscillation;
for given FO configuration at steady-state equilibrium, coefficients aᵢ(i=0̅,̅3̅) of equation (11) are fixed; therefore, parameters τₛ, τᵣ, ζ_{D}, ω_{D} are found by solving equation (11) using a “roots” command in MATLAB;
step 3: construct a general transfer function of the roll channel, step 3 assumes that an influence of the control surface deflection angle δₐ on the yawing moment and lateral force is very small, so the aerodynamic coefficients
$${C}_{{n}_{{δ}_{a}}} and {C}_{{y}_{{δ}_{a}}}$$
can be neglected; the general transfer function of the roll channel with input signal δₐ and output signal φ is:
$$\frac{ϕ ( s )}{{δ}_{a} ( s )} = \frac{{L}_{{δ}_{a}} \vert \begin{matrix}s - {N}_{r} & - {N}_{β} \\ U - {Y}_{r} & Us - {Y}_{β}\end{matrix} \vert}{∇} \qquad ( 13 )$$
notation:
$${∇}_{D R} = \vert \begin{matrix}s - {N}_{r} & - {N}_{β} \\ U - {Y}_{r} & Us - {Y}_{β}\end{matrix} \vert \qquad ( 14 )$$
an expansion of equation (14) is:
$${∇}_{D R} = {Us}^{2} - ( {Y}_{β} + {UN}_{r} ) s + {Y}_{β} {N}_{r} - {N}_{β} {Y}_{r} + {UN}_{β} \qquad ( 15 )$$
equation (15) can be rewritten in the following form:
$${∇}_{D R} = U {ω}_{D R}^{2} [ {( \frac{s}{{ω}_{D R}} )}^{2} + \frac{2 {ζ}_{D R}}{{ω}_{D R}} s + 1 ] \qquad ( 16 )$$
ζ_{DR} and ω_{DR} are determined by the following expressions:
$${ζ}_{D R} = - \frac{1}{2 {ω}_{D R}} \frac{{Y}_{β} + {UN}_{r}}{U} \qquad ( 17 )$$
$${ω}_{D R} = \sqrt{\frac{{y}_{β} {N}_{r} - {N}_{β} {Y}_{r} + {UN}_{β}}{U}} \qquad ( 18 )$$
the general transfer function of the roll channel is:
$$\frac{ϕ ( s )}{{δ}_{a} ( s )} = \frac{{L}_{{δ}_{a}} {τ}_{s} {{τ}_{r} ( \frac{{ω}_{DR}}{{ω}_{D}} )}^{2} [ {( \frac{s}{{ω}_{DR}} )}^{2} + \frac{2 {ζ}_{DR}}{{ω}_{DR}} s + 1 ]}{( {τ}_{s} s + 1 ) ( {τ}_{r} s + 1 ) [ {( \frac{s}{{ω}_{D}} )}^{2} + \frac{2 {ζ}_{D}}{{ω}_{D}} s + 1 ]} \qquad ( 19 )$$
step 4: derive a reduced transfer function of the roll channel from the general transfer function; observing equation (19), if ω_{DR} is very close to ω_{D} and ζ_{DR} is very close to ζ_{D}, the roll angle transfer function can be approximated as follows:
$$\frac{ϕ ( s )}{{δ}_{a} ( s )} = \frac{{K}_{x}}{( {τ}_{s} s + 1 ) ( {τ}_{r} s + 1 )} \qquad ( 20 )$$
where Kₓ is determined by an expression:
$${K}_{x} = {L}_{{δ}_{l}} {τ}_{s} {{τ}_{r} ( \frac{{ω}_{D R}}{{ω}_{D}} )}^{2} \qquad ( 21 )$$
the transfer function of the roll angular velocity with the input signal being the roll channel control angle δₐ is:
$$\frac{\dot{ϕ} ( s )}{{δ}_{a} ( s )} = \frac{{K}_{x} s}{( {τ}_{s} s + 1 ) ( {τ}_{r} s + 1 )} . \qquad ( 22 ) .$$
